(19) United States
(12) Patent Application Publication
(10) Pub. No.: US 2026/0027578 A1
(43) Pub. Date: Jan. 29, 2026

(54) Grass Gasket Device

(71) Applicant: Richard Stoebel, The Villages, FL (US)

(72) Inventor: Richard Stoebel, The Villages, FL (US)

(21) Appl. No.: 19/175,145

(22) Filed: Apr. 10, 2025

Related U.S. Application Data
(60) Provisional application No. 63/675,285, filed on Jul. 25, 2024.

(51) Int. Cl. B05B 15/16; A01G 25/00

(52) U.S. Cl. CPC B05B 15/16; A01G 25/00

(57) ABSTRACT

A grass gasket device is disclosed which improves the effectiveness of concrete irrigation system donuts by stopping the invasive growth of grass and weeds. The grass gasket device comprises a body component that is configured in a round or circular shape with a through-hole in the center. The size and shape of the body component is sized and shaped to match an irrigation donut. In use, the body component is affixed to an underside of the irrigation donut via a strong, durable adhesive material. The center through-hole matches the size of the sprinkler body and comprises four slits that radiate out from the center through-hole. The center through-hole and radial slits allow the body component and irrigation donut to pass over the larger sprinkler head to form a barrier for weed growth.

### CROSS-REFERENCE TO RELATED APPLICATION

The present application claims priority to, and the benefit of, U.S. Provisional Application No. 63/675,285, which was filed on Jul. 25, 2024, and is incorporated herein by reference in its entirety.

### FIELD OF THE INVENTION

The present invention relates generally to the field of grass gasket devices. More specifically, the present invention relates to a rubber gasket affixed to the bottom of a concrete irrigation donut. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in grass gasket devices. Generally, lawn and garden irrigation systems typically require consistent maintenance to operate efficiently. Further, homeowners may opt to purchase concrete donuts that are placed over each sprinkler head. However, these do not sufficiently protect popup nozzles from invasive grass and weeds, ultimately requiring maintenance with tooling and labor. Additionally, maintenance is time consuming and costly if a homeowner is not able to perform the work and is forced to hire professional landscaping help.

In-ground sprinkler heads are common for both residential and commercial landscapes. The functionality of the sprinkler heads can be inhibited by debris growing or gathering about the top of the sprinkler head. Further, the serviceability can be inhibited by dirt, growth, and debris encroaching into the cavity where the sprinkler head resides. The dirt and debris surrounding a sprinkler head cavity makes it difficult to remove, replace, and service a sprinkler head. Additionally, growth and debris can cover the sprinkler head further inhibiting functionality and serviceability of the sprinkler head. A device is needed to maintain a sprinkler head free from growth and debris across the top of a sprinkler head.

Accordingly, there is a demand for an improved grass gasket device that functions as a barrier between soil and the irrigation head to prevent invasive weed growth. More particularly, there is a demand for a grass gasket device that eliminates the need to use mowers or string trimmers around the irrigation head and risk damage.

Therefore, there exists a long felt need in the art for a grass gasket device that provides users with a rubber gasket affixed to the bottom of a concrete irrigation donut. There is also a long felt need in the art for a grass gasket device that features a hole with four slits that radiate from the center, enabling the gasket to fit perfectly around the sprinkler head. Further, there is a long felt need in the art for a grass gasket device that functions as a barrier between soil and the irrigation head to prevent invasive weed growth. Moreover, there is a long felt need in the art for a device that eliminates the need to use mowers or string trimmers around the irrigation head and risk damage. Further, there is a long felt need in the art for a grass gasket device that is adhered to the irrigation donut via a strong, durable adhesive material. Finally, there is a long felt need in the art for a grass gasket device that measures approximately six inches in diameter.

The subject matter disclosed and claimed herein, in one embodiment thereof, comprises a grass gasket device. The device improves the effectiveness of concrete irrigation system donuts by stopping the invasive growth of grass and weeds. The grass gasket device comprises a body component that is configured in a round or circular shape with a through-hole in the center. The size and shape of the body component is sized and shaped to match an irrigation donut. In use, the body component is affixed to an underside of the irrigation donut via a strong, durable adhesive material. The center through-hole matches the size of the sprinkler body and comprises four slits that radiate out from the center through-hole. The center through-hole and radial slits allow the body component and irrigation donut to pass over the larger sprinkler head. Each irrigation donut is approximately six inches in diameter with the grass gasket device measuring approximately six inches in diameter. Once the body component is affixed to an underside of the irrigation donut, it can be slid over the sprinkler head to form a barrier and prevent the growth of grass, weeds, etc.

In this manner, the grass gasket device of the present invention accomplishes all of the forgoing objectives and provides users with a device that functions as a barrier to prevent invasive weed growth. The device is a rubber gasket applied to an underside of the irrigation donut. The device is slid over a sprinkler head for use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a grass gasket device. The device improves the effectiveness of concrete irrigation system donuts by stopping the invasive growth of grass and weeds. The grass gasket device comprises a body component that is sized and shaped to match an irrigation donut. In use, the body component is affixed to an underside of the irrigation donut and the center through-hole passes over the larger sprinkler head, forming a barrier to prevent the growth of grass, weeds, etc.

In one embodiment, the grass gasket device provides users with a rubber gasket affixed to the bottom of an irrigation donut. In use, the device functions as a barrier between soil and the sprinkler head to prevent invasive weed growth. Thus, the grass gasket device eliminates the need to use mowers or string trimmers around the sprinkler head and risk damage to the sprinkler head.

In one embodiment, the grass gasket device is utilized with an irrigation donut during use. Irrigation donuts are typically concrete rings that are placed around sprinkler heads to protect them from damage. Irrigation donuts are approximately six inches in diameter with a center through-hole. They are designed to displace the weight of a vehicle or lawn mower tire that runs over them and prevent the sprinkler head and the connecting pipes from cracking. Irrigation donuts are usually green dyed to blend in with the grass. However, the irrigation donuts do not sufficiently protect pop-up sprinkler nozzles from invasive grass and weeds, ultimately requiring maintenance with tooling and labor. The grass gasket device is secured to the irrigation donut to improve the effectiveness of the concrete irrigation donut by stopping the invasive growth of grass and weeds over the sprinkler head.

In one embodiment, the grass gasket device comprises a body component that is configured in a round or circular shape to mirror the shape of the irrigation donut. However, whereas the irrigation donut is rounded, thick, and donut-shaped, the body component is a flat, circular shape with a top surface, rear surface, and a circular through-hole.

In one embodiment, the irrigation donut comprises a top surface, a bottom surface, a curved sidewall, and a center through-hole. In use, the top surface of the body component of the grass gasket device is affixed to an underside (i.e., the bottom surface) of the irrigation donut via a strong, durable adhesive material. In one embodiment, the adhesive is a gap-filling, polyethylene or polystyrene adhesive material, however, the adhesive can be any suitable adhesive material as is known in the art.

In one embodiment, the center through-hole of the body component matches the size of the sprinkler body it is to be positioned around during use. Further, the center through-hole comprises four slits that radiate out from the center through-hole. The radial slits allow the body component to pass over the larger sprinkler head during use, and then close around the center through-hole to surround the sprinkler body and create a barrier for weeds and grass.

In one embodiment, the size and shape of the body component is sized and shaped to match an irrigation donut. Specifically, each irrigation donut is approximately six inches in diameter with the grass gasket device also measuring approximately six inches in diameter.

In use, the body component of the grass gasket device is affixed to an underside of the irrigation donut via a strong, durable adhesive material. The irrigation donut and secured body component are then positioned over a sprinkler head via their center through-holes. Once in position around the sprinkler body, the grass gasket device creates a barrier preventing invasive weeds and grass from growing over the sprinkler head.

In one embodiment, the grass gasket device is manufactured from rubber, neoprene, polyethylene, silicone rubber, etc., or any other suitable materials as is known in the art, or a combination of such materials.

In yet another embodiment, the grass gasket device comprises a plurality of indicia.

In yet another embodiment, a method of preventing invasive weed growth around a sprinkler head is disclosed. The method includes the steps of providing a grass gasket device comprising a body component with a center through-hole having four radial slits. The method also comprises securing the body component to an underside of an irrigation donut. Further, the method comprises positioning the irrigation donut and attached grass gasket over a sprinkler head. The method also comprises securing the irrigation donut and attached grass gasket around a sprinkler body via the four radial slits. Finally, the method comprises creating a barrier to prevent invasive weed growth.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the grass gasket device of the present invention showing the device and an unprotected sprinkler head in accordance with the disclosed architecture;

FIGS. 2A-B illustrate a perspective view of one embodiment of the grass gasket device of the present invention showing the irrigation donut and gasket device in accordance with the disclosed architecture;

FIGS. 3A-B illustrate a perspective view of one embodiment of the grass gasket device of the present invention showing how the gasket device is affixed to the irrigation donut in accordance with the disclosed architecture;

FIGS. 4A-B illustrate a cross-sectional view of one embodiment of the grass gasket device of the present invention showing the gasket device positioned around a sprinkler head in accordance with the disclosed architecture;

FIG. 5 illustrates a cross-sectional view of one embodiment of the grass gasket device of the present invention showing the device in use in accordance with the disclosed architecture; and

FIG. 6 illustrates a flowchart showing the method of preventing invasive weed growth around a sprinkler head in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a grass gasket device that provides users with a rubber gasket affixed to the bottom of a concrete irrigation donut. There is also a long felt need in the art for a grass gasket device that features a hole with four slits that radiate from the center, enabling the gasket to fit perfectly around the sprinkler head. Further, there is a long felt need in the art for a grass gasket device that functions as a barrier between soil and the irrigation head to prevent invasive weed growth. Moreover, there is a long felt need in the art for a device that eliminates the need to use mowers or string trimmers around the irrigation head and risk damage. Further, there is a long felt need in the art for a grass gasket device that is adhered to the irrigation donut via a strong, durable adhesive material. Finally, there is a long felt need in the art for a grass gasket device that measures approximately six inches in diameter.

The present invention, in one exemplary embodiment, is a novel grass gasket device. The device improves the effectiveness of concrete irrigation system donuts by stopping the invasive growth of grass and weeds. The grass gasket device comprises a body component that is configured in a round or circular shape with a through-hole in the center. The size and shape of the body component is sized and shaped to match an irrigation donut. In use, the body component is affixed to an underside of the irrigation donut via a strong, durable adhesive material. The material will meet the requirements of subterranean, weatherproof, and/or external in that the device may be used outdoors. The center through-hole matches the size of the sprinkler body and comprises four slits that radiate out from the center through-hole. The center through-hole and radial slits allow the body component and irrigation donut to pass over the larger sprinkler head to create a barrier for invasive weed growth. The present invention also includes a novel method of preventing invasive weed growth around a sprinkler head. The method includes the steps of providing a grass gasket device comprising a body component with a center through-hole having four radial slits. The method also comprises securing the body component to an underside of an irrigation donut. Further, the method comprises positioning the irrigation donut and attached grass gasket over a sprinkler head. The method also comprises securing the irrigation donut and attached grass gasket around a sprinkler body via the four radial slits. Finally, the method comprises creating a barrier to prevent invasive weed growth. While the preferred color of the rubber is red, the rubber may be any color including, but not limited to, green.

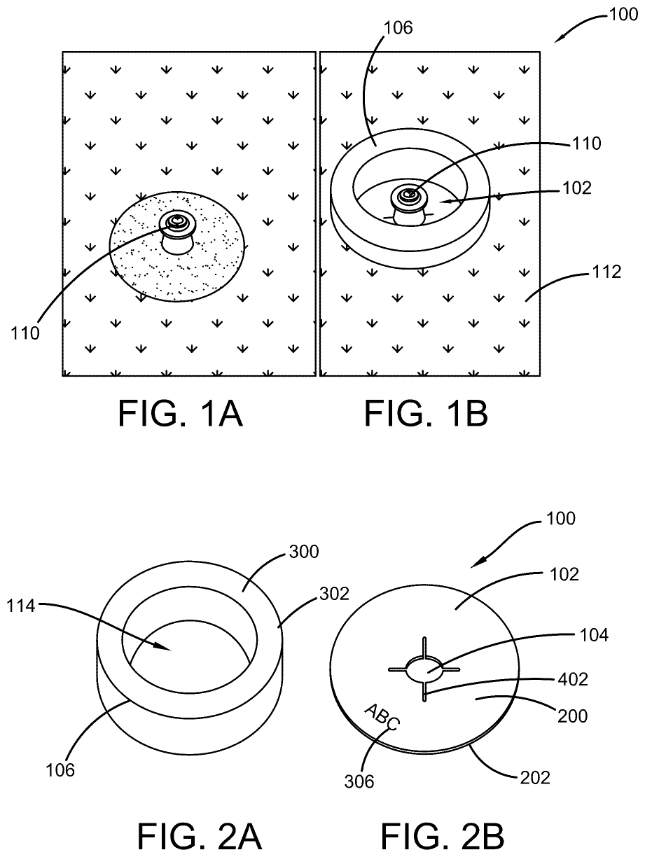

Referring initially to the drawings, FIGS. 1A-B illustrate a perspective view of one embodiment of the grass gasket device 100 of the present invention. In the present embodiment, the grass gasket device 100 is an improved grass gasket device 100 that provides a user with a means for stopping the invasive growth of grass 112 and weeds of a sprinkler head 110. Specifically, the grass gasket device 100 comprises a body component 102 with a center through-hole 104 that is sized and shaped to match an irrigation donut 106. In use, the body component 102 is affixed to an underside 108 of the irrigation donut 106 and the center through-hole 104 passes over the larger sprinkler head 110, forming a barrier to prevent the growth of grass 112, weeds, etc.

Generally, the grass gasket device 100 provides users with a rubber gasket affixed to the bottom 108 of an irrigation donut 106. In use, the device 100 functions as a barrier between soil and the sprinkler head 110 to prevent invasive weed 112 growth. Thus, the grass gasket device 100 eliminates the need to use mowers or string trimmers around the sprinkler head 110 and risk damage to the sprinkler head 110.

Further, the grass gasket device 100 is utilized with an irrigation donut 106 during use. Irrigation donuts 106 are typically concrete rings that are placed around sprinkler heads 110 to protect them from damage. Irrigation donuts 106 are approximately six inches in diameter with a center through-hole 114. They are designed to displace the weight of a vehicle or lawn mower tire that runs over them and prevent the sprinkler head 110 and the connecting pipes from cracking. Irrigation donuts 106 are usually green dyed to blend in with the grass 112. However, the irrigation donuts 106 do not sufficiently protect pop-up sprinkler nozzles 110 from invasive grass 112 and weeds, ultimately requiring maintenance with tooling and labor. The grass gasket device 100 is secured to the irrigation donut 106 to improve the effectiveness of the concrete irrigation donut 106 by stopping the invasive growth of grass 112 and weeds over the sprinkler head 110.

As shown in FIGS. 2A-B, the grass gasket device 100 comprises a body component 102 that is configured in a round or circular shape to mirror the shape of the irrigation donut 106. However, whereas the irrigation donut 106 is rounded, thick, and donut-shaped, the body component 102 is a flat, circular shape with a top surface 200, rear surface 202, and a circular through-hole 104.

In one embodiment, the size and shape of the body component 102 is sized and shaped to match an irrigation donut 106. Specifically, each irrigation donut 106 is approximately six inches in diameter with the grass gasket device 100 also measuring approximately six inches in diameter. However, any suitable sizes of the irrigation donut 106 and grass gasket device 100 can be utilized as is known in the art, depending on the sprinkler size and user's wants and/or needs.

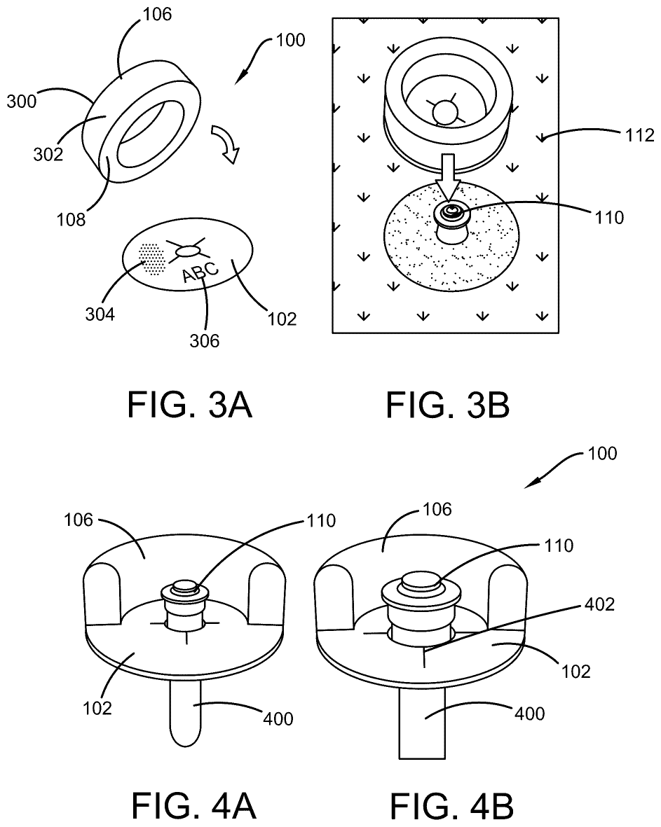

As shown in FIGS. 3A-B, the irrigation donut 106 comprises a top surface 300, a bottom surface 108, a curved sidewall 302, and a center through-hole 114. In use, the top surface 200 of the body component 102 of the grass gasket device 100 is affixed to an underside (i.e., the bottom surface 108) of the irrigation donut 106 via a strong, durable adhesive material 304. In one embodiment, the adhesive 304 is a gap-filling, polyethylene or polystyrene adhesive material, however, the adhesive 304 can be any suitable adhesive material as is known in the art.

Typically, the grass gasket device 100 is manufactured from rubber, neoprene, polyethylene, silicone rubber, etc., or any other suitable materials as is known in the art, or a combination of such materials.

In yet another embodiment, the grass gasket device 100 comprises a plurality of indicia 306. The body component 102 of the device 100 may include advertising, a trademark, or other letters, designs, or characters, printed, painted, stamped, or integrated into the body component 102, or any other indicia 306 as is known in the art. Specifically, any suitable indicia 306 as is known in the art can be included, such as but not limited to, patterns, logos, emblems, images, symbols, designs, letters, words, characters, animals, advertisements, brands, etc., that may or may not be sprinkler, irrigation, or brand related.

As shown in FIGS. 4A-B, the center through-hole 104 of the body component 102 matches the size of the sprinkler body 400 it is to be positioned around during use. Further, the center through-hole 104 comprises four slits 402 that radiate out from the center through-hole 104. The radial slits 402 allow the body component 102 to pass over the larger sprinkler head 110 during use, and then close around the center through-hole 104 to surround the sprinkler body 400 and create a barrier for weeds and grass 112.

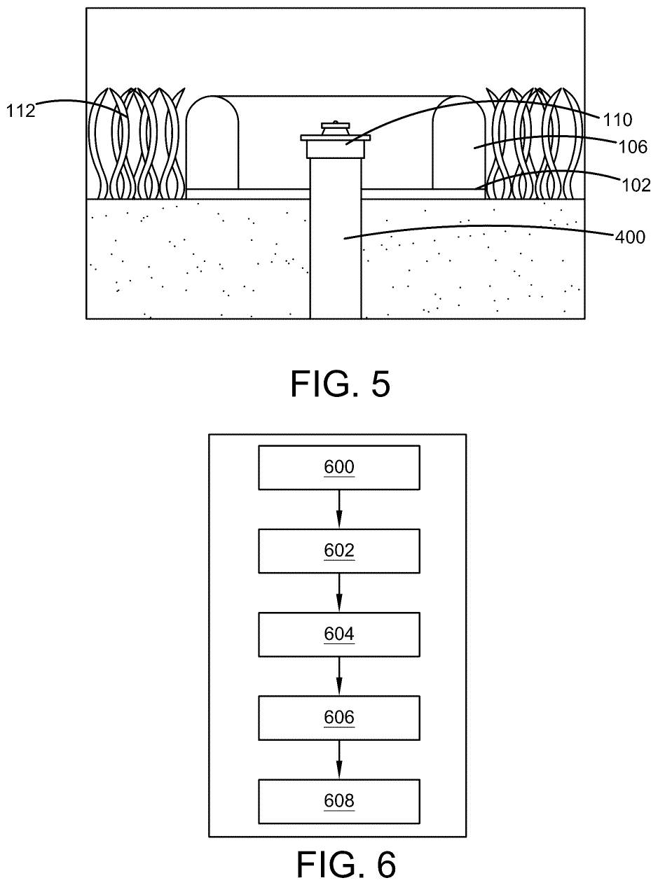

As shown in FIG. 5, in use, the body component 102 of the grass gasket device 100 is affixed to an underside 108 of the irrigation donut 106 via a strong, durable adhesive material 304. The irrigation donut 106 and secured body component 102 are then positioned over a sprinkler head 110 via their center through-holes 104, 114. Once in position around the sprinkler body 400, the grass gasket device 100 creates a barrier preventing invasive weeds and grass 112 from growing over the sprinkler head 110.

FIG. 6 illustrates a flowchart of the method of preventing invasive weed growth around a sprinkler head. The method includes the steps of at 600, providing a grass gasket device comprising a body component with a center through-hole having four radial slits. The method also comprises at 602, securing the body component to an underside of an irrigation donut. Further, the method comprises at 604, positioning the irrigation donut and attached grass gasket over a sprinkler head. The method also comprises at 606, securing the irrigation donut and attached grass gasket around a sprinkler body via the four radial slits. Finally, the method comprises at 608, creating a barrier to prevent invasive weed growth.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “grass gasket device”, “gasket device”, and “device” are interchangeable and refer to the grass gasket device 100 of the present invention.

Notwithstanding the forgoing, the grass gasket device 100 of the present invention can be of any suitable size and configuration as is known in the art without affecting the overall concept of the invention, provided that it accomplishes the above stated objectives. One of ordinary skill in the art will appreciate that the grass gasket device 100 as shown in FIGS. 1-6 is for illustrative purposes only, and that many other sizes and shapes of the grass gasket device 100 are well within the scope of the present disclosure. Although the dimensions of the grass gasket device 100 are important design parameters for user convenience, the grass gasket device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A grass gasket device that provides a user with a means for stopping the invasive growth of grass and weeds over a sprinkler head, the grass gasket device comprising:
a body component;
wherein the body component includes a center through-hole;
wherein the body component is affixed to an underside of an irrigation donut; and
further wherein the body component and the irrigation donut are positioned over a sprinkler head, forming a barrier to prevent invasive growth of grass and weeds.

2. The grass gasket device of claim 1, wherein the body component is affixed to an irrigation donut that is approximately six inches in diameter.

3. The grass gasket device of claim 2, wherein the body component is configured in a flat, circular shape to mirror shape of the irrigation donut.

4. The grass gasket device of claim 3, wherein the body component has a top surface, a rear surface, and the center through-hole.

5. The grass gasket device of claim 4, wherein the irrigation donut comprises a top surface, a bottom surface, a curved sidewall, and a center through-hole.

6. The grass gasket device of claim 5, wherein the top surface of the body component of the grass gasket device is affixed to the bottom surface of the irrigation donut via an adhesive.

7. The grass gasket device of claim 6, wherein the adhesive is a gap-filling, polyethylene or polystyrene adhesive material.

8. The grass gasket device of claim 7, wherein the grass gasket device is manufactured from rubber, neoprene, polyethylene, or silicone rubber, or a combination of such materials.

9. The grass gasket device of claim 8 further comprising a plurality of indicia.

10. The grass gasket device of claim 9, wherein the center through-hole of the body component matches size of a sprinkler body it is to be positioned around during use.

11. The grass gasket device of claim 10, wherein the center through-hole comprises four slits that radiate out from the center through-hole.

12. The grass gasket device of claim 11, wherein the four slits allow the body component to pass over a larger sprinkler head during use, and then close around the center through-hole to surround the sprinkler body and create a barrier for weeds and grass.

13. A grass gasket device that provides a user with a means for stopping the invasive growth of grass and weeds over a sprinkler head, the grass gasket device comprising:
a body component comprising a top surface, a rear surface, and a center through-hole;
wherein the body component is affixed to an irrigation donut;
wherein the irrigation donut comprises a top surface, a bottom surface, a curved sidewall, and a center through-hole;
wherein the top surface of the body component of the grass gasket device is affixed to the bottom surface of the irrigation donut via an adhesive;
wherein the center through-hole of the body component matches size of a sprinkler body it is to be positioned around during use;
wherein the center through-hole of the body component comprises four slits that radiate out from the center through-hole; and
further wherein the four slits allow the body component to pass over a larger sprinkler head during use, and then close around the center through-hole to surround the sprinkler body and create a barrier for weeds and grass.

14. The grass gasket device of claim 13, wherein the body component is configured in a flat, circular shape to mirror shape of the irrigation donut.

15. The grass gasket device of claim 13, wherein the body component is affixed to an irrigation donut that is approximately six inches in diameter.

16. The grass gasket device of claim 15, wherein the body component is approximately six inches in diameter.

17. The grass gasket device of claim 13, wherein the adhesive is a gap-filling, polyethylene or polystyrene adhesive material.

18. The grass gasket device of claim 13, wherein the grass gasket device is manufactured from rubber, neoprene, polyethylene, or silicone rubber, or a combination of such materials.

19. The grass gasket device of claim 13 further comprising a plurality of indicia.

20. A method of preventing invasive weed growth around a sprinkler head, the method comprising the following steps:
providing a grass gasket device comprising a body component with a center through-hole having four radial slits;
securing the body component to an underside of an irrigation donut;
positioning the irrigation donut and attached grass gasket over a sprinkler head;
securing the irrigation donut and attached grass gasket around a sprinkler body via the four radial slits; and
creating a barrier to prevent invasive weed growth.
